(19) United States
(12) Patent Application Publication
(10) Pub. No.: US 2016/0078257 A1
(43) Pub. Date: Mar. 17, 2016

(54) ULTRAHIGH FREQUENCY RFID (RADIO FREQUENCY IDENTIFICATION) READER WITH SIGHTING FUNCTION

(71) Applicant: MARSON TECHNOLOGY CO., LTD., New Taipei City (TW)

(72) Inventor: Ting-Fong LIOU, New Taipei City (TW)

(21) Appl. No.: 14/485,393

(22) Filed: Sep. 12, 2014

(51) Int. Cl. G06K 7/10

(52) U.S. Cl. CPC G06K 7/10316

(57) ABSTRACT

An ultrahigh frequency (UHF) radio frequency identification (RFID) reader with sighting function for reading RFID tag is mainly formed by a RF antenna and a controller, wherein the physical appearance of the RF antenna is formed with a sighting portion. In reading operation, users can aim the sighting portion of the RF antenna at a RFID tag at a remote location by visual mode so that the RF antenna can finish the reading operation promptly and accurately. Therefore, the reading accuracy and efficiency and power consumption can be improved.

### BACKGROUND OF INVENTION

1. Field of the Invention

The present invention relates to an ultrahigh frequency (UHF) radio frequency identification (RFID) reader, more particularly to an UHF RFID reader with sighting function, by which rapid aiming at RFID tag to be read can be achieved.

2. Brief Description of Prior Art

Radio frequency identification (RFID) is a technology widely used in contactless wireless communication. When in implementation, RFID is usually formed by at least one RFID reader and several RFID tags. As it has advantages of high data safety, reusability, good penetration, fast reading speed, it gradually replaces conventional bar code identification and largely used in our daily life, such as health care, logistic, personal authentication identification. FIG. 1 shows a conventional UHF RFID reader 10, the frequency band range of its RF antenna is within 865˜960 MHz and the effective sensing range is 1˜10 meters, the application of which is focus in extending its sensing range so as to facilitate the application and usage. However, as the wave emitted by the RF antenna is a directional wave, the farther the wave away from the RF antenna is, the more serious the degree of narrowing it becomes. Thus, if users cannot aim the RF antenna at a remote RFID tag 11 to be sensed, it often happens to have the cases of failure in sensing. Therefore, it is very common that users has to change the position of UHF RFID reader 10 constantly in order to sight the RFID tag, this often causes great inconvenience during its overall operation. Furthermore, in the process of transmitting and sensing radio waves repeatedly, the power of the UHF RFID reader 10 is rapidly consumed.

### SUMMARY OF THE INVENTION

In view of the above problems and demands, the main object of the present invention is to provide an UHF RFID reader with sighting function, which not only can read RFID tag promptly and accurately but also can save power consumption.

In order to achieve above objects, the UHF RFID reader with sighting function of the present invention is formed by a RF antenna and a controller, the RF antenna being assembled at the front end of the controller. The physical appearance of the radio frequency antenna is formed with a sighting portion. When a user want to read a RFID tag at remote place by the UHF RFID reader with sighting function, user can aim the sighting portion of the RF antenna at the RFID tag to be read by visual mode such that the line of sight, the sighting portion and the RFID tag are aligned on a line. Then, the controller actuates the RF antenna to emit a radio wave. In this manner, the effect of rapid aiming and accurate sensing can be achieved so as to solve the problem of failing to promptly aim at RFID tag happened in conventional UHF RFID reader. Furthermore, the reading operation conducted after aiming at the RFID tag enables effective use of power so as to achieve power saving purpose.

### BRIEF DESCRIPTION OF ACCOMPANYING DRAWINGS

FIG. 1 is a perspective view of a conventional UHF RFID reader.

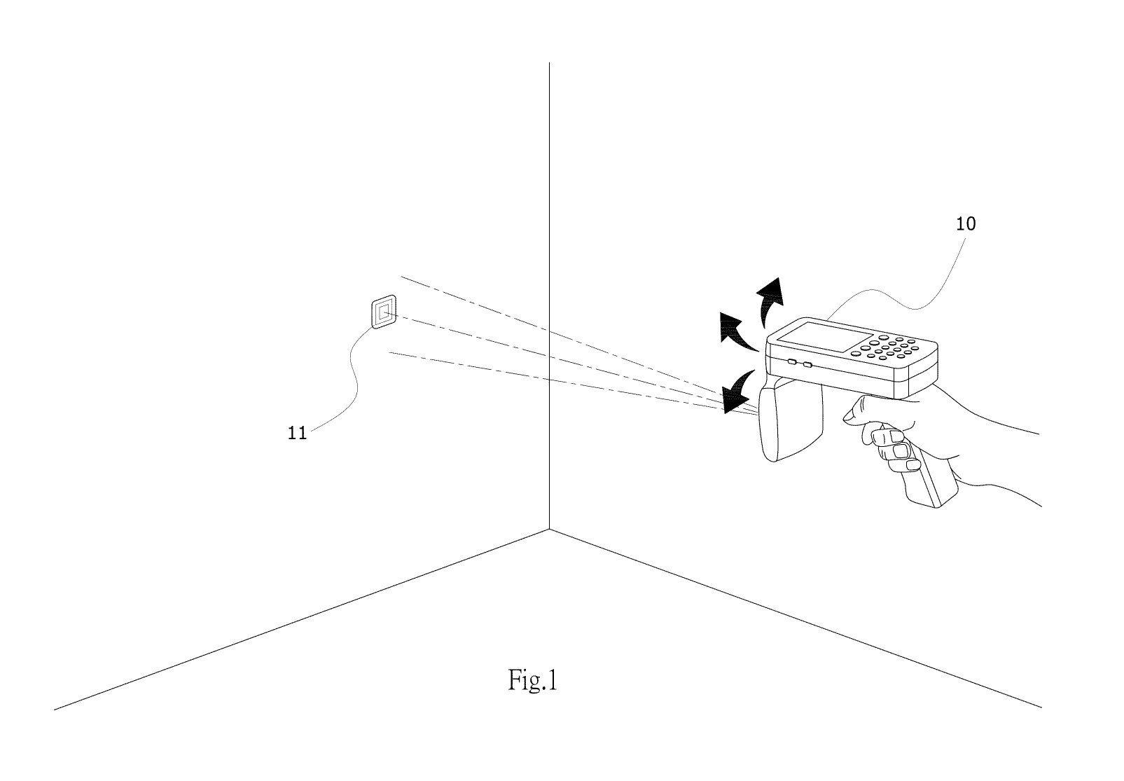

FIG. 2 is a perspective view of the appearance of the present invention.

FIG. 3 is a block diagram view showing the structure of the present invention.

FIG. 4 is a schematic view showing the implementation of the present invention.

FIG. 5 is another perspective schematic view showing the appearance of the present invention.

### DETAILED DESCRIPTION OF PREFERRED EMBODIMENTS

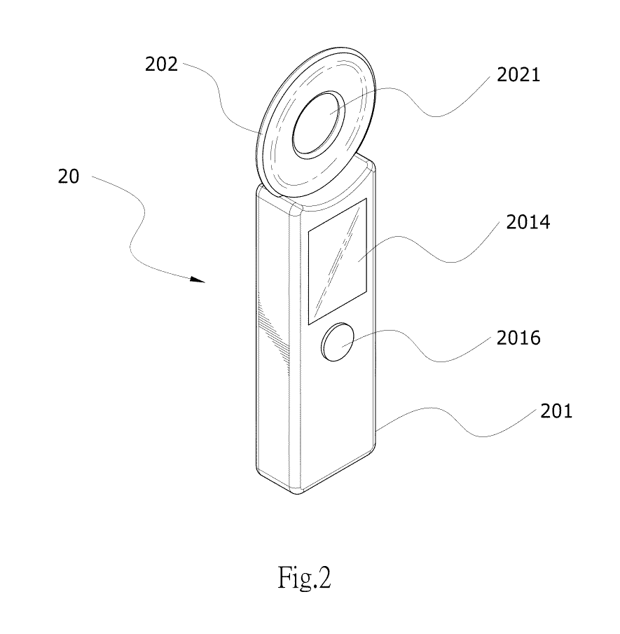

Referring to FIG. 2, a perspective view of the present invention, the UHF RFID reader 20 with sighting function of the present invention is mainly formed by a controller 201 and a RF antenna 202. On the physical appearance of the RF antenna 202, a sighting portion 2021 of through-hole shape is formed to have the function similar to a front sight of firearm. Alternatively, the sighting portion 2021 can also be formed as the other type such as a cross hole, a diamond hole, but is not limited to these. Further, the RF antenna 202 is assembled on one end of the controller 201 and is in electrical connection and in information linking to the controller 201. The controller 201 has a display screen 2014 and at least one operation key(s) 2016 by which users can operate so as to watch information displayed on the screen 2014. Therefore, when the controller 201 is operated by users, the RF antenna 202 is driven to emit a radio wave and to conduct sensing a RF tag at remote location. Further, the appearance of the RF antenna 202 is preferably to be circular in shape, but polygonal or irregular in shape is also acceptable.

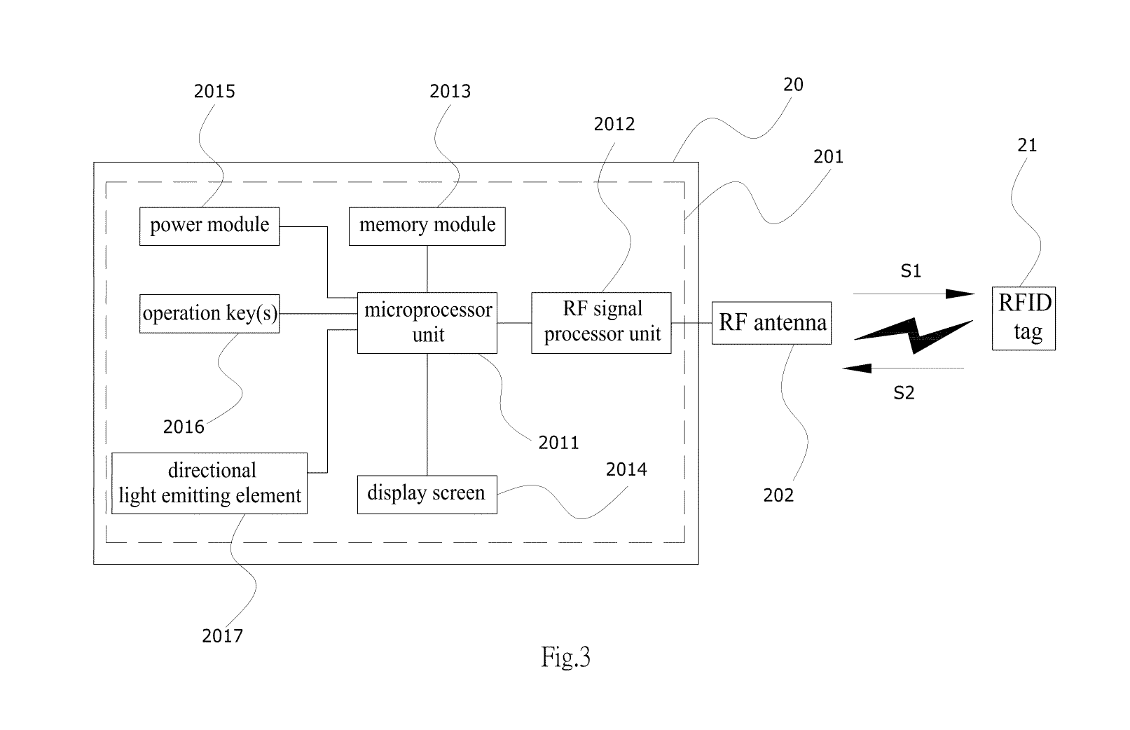

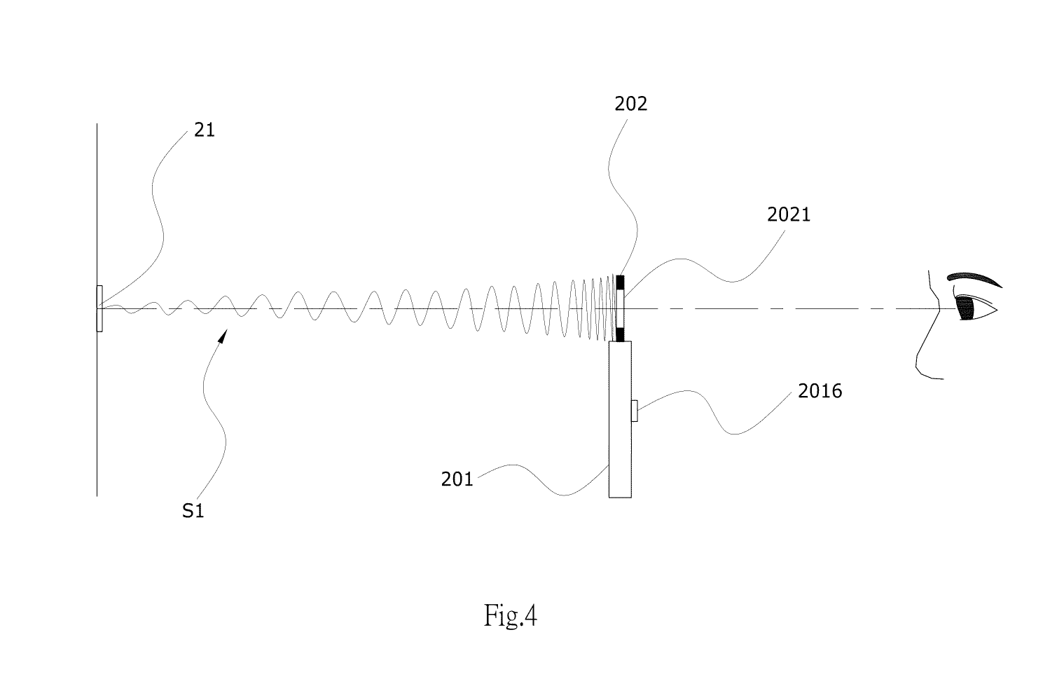

According to the UHF RFID reader 20 with sighting function of the present invention, as shown in FIGS. 3 and 4, the controller 201 comprises a microprocessor unit 2011, a RF signal processor unit 2012, a memory module 2013, a display screen 2014, a power module 2015, a operation key(s) 2016 and a directional light emitting element 2017. The RF antenna 202 is electrically coupled to the RF signal processor unit 2012. Further, the RF signal processor unit 2012, the memory module 2013, the display screen 2014, the power module 2015, the operation key(s) 2016 and the directional light emitting element 2017 are electrically coupled to the microprocessor unit 2011 respectively. Furthermore, the RF antenna 202 is used to transmit and receive radio wave (to transmit radio wave S1, to receive radio wave S2), while the RF signal processor unit 2012 is used to process the radio wave from RFID tag 21 and actuate the RF antenna 202 to transmit radio wave, and the power module 2015 is to provide required electricity for each module. Thus, after the RF antenna 202 transmits the radio wave S1, a RFID tag 21 is driven by the energy of the radio wave S1 to respond an identification signal S2, and the identification signal S2 is received by the RF antenna 202 and processed by the RF processor unit 2012, then is transferred to the microprocessor unit 2011 for decoding. The information after decoding is stored in the memory module 2013 and is displayed on the display screen 2014 of the controller 201.

Referring to FIGS. 4 and 3, when a RFID tag 21 at remote place is to be read by the present invention, user merely holds the controller 201 by his hand and align his line of sight with the sighting portion 2021 of the RF antenna 202, then extends his line of sight to the RFID tag 21 to be read so that the line of sight, the sighting portion 2021 and the RFID tag 21 form a virtual straight line. In this manner, the effect of rapid aiming at the remote RFID tag 21 can be achieved. At this moment, user further operates the operation key(s) 2016 of the controller 201 so that the controller 201 transmits radio wave S1 through the RF antenna 202 (referring to the signal transmitting and receiving mode in FIG. 3). In this way, the effect of rapid aiming and accurate reading of the RFID tag 21 can be achieved.

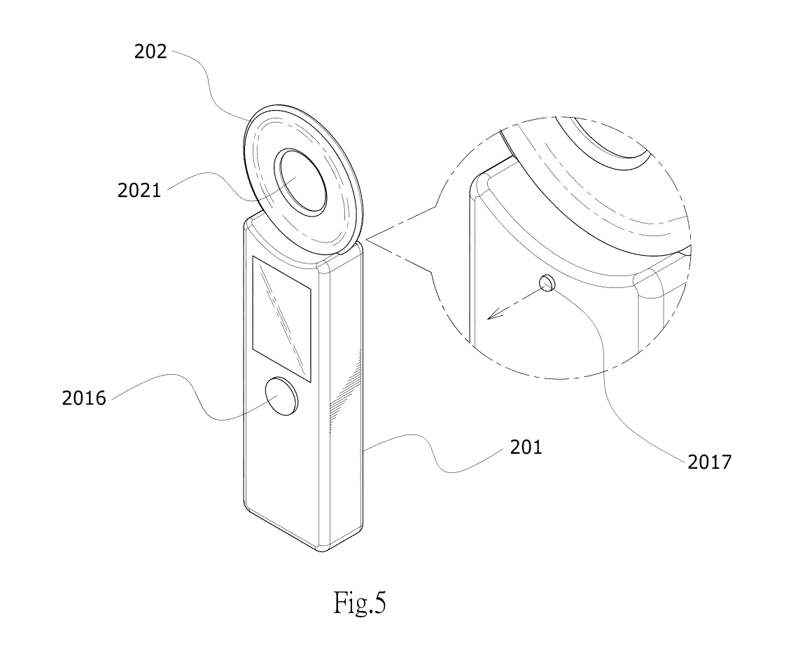

Referring to FIG. 5, the RF antenna 202 is assembled on one end of the controller 201 and the RF antenna 202 is formed with a sighting portion 2021. Further, a directional light emitting element 2017 (such as a laser diode) is assembled on the controller 201 so as to serve as a light source of direction indicating. When operating in dim environment or at night, user can aim at the RFID tag 21 at specific location promptly through the assistance of the directional light emitting element 2017.

Based on the foregoing, the UHF RFID reader with sighting function of the present invention transmits a radio wave to a RFID tag to be read through a RF antenna provided at the front end of a controller, then receives an identification signal responded by the RFID tag through the RF antenna, so as to finish the reading process. Furthermore, this invention is to allow the physical appearance of the RF antenna to have a sighting portion, so that the RF antenna can sight the RFID tag at a remote location accurately by the function of the sighting portion beforehand, when user operates it. Therefore, the reading operation becomes more accurate. It is apparent from the structure and the implementation content stated above, this invention can allow the UHF RFID reader with sighting function to aim at remote RFID tag promptly and accurately, so that it is unnecessary to drive the UHF RFID reader with sighting function continually for reading RFID tag, hence unnecessary power consumption can be reduced. Summing up above, the present invention, after implementation, surely can achieve the purpose of providing an UHF RFID reader with sighting function, which can read RFID tag promptly and accurately and save power consumption.

1. An ultra high frequency (UHF) radio frequency identification (RFID) reader with sighting function used to read a RFID tag, comprising:
a controller;
a RF antenna having a sighting portion formed thereon, said RF antenna being assembled at the front end of said controller, said controller and said RF antenna being in electrical connection and information linking relationship;
an user merely holds said controller by his hand and align his line of sight with said sighting portion of said RF antenna so that the line of sight, said sighting portion and said RFID tag form a virtual straight line, so as to achieve the function of aiming at said RFID tag promptly.

2. The UHF RFID reader with sighting function as claimed in claim 1, wherein a directional light emitting element is assembled on said controller to serve as a light source of direction indicating, which can achieve the effect of promptly aiming at the said RFID tag at a specific location.

3. The UHF RFID reader with sighting function as claimed in claim 1, wherein said sighting portion is formed as anyone selected from a circular hole, a cross hole or a diamond hole in shape.
